(19) United States
(12) Patent Application Publication
(10) Pub. No.: US 2016/0358247 A1
(43) Pub. Date: Dec. 8, 2016

(54) NETWORKED ELECTRONICALLY PROGRAMMABLE DYNAMIC DISPLAYS ON PERSONAL AND COMMERCIAL PROPERTIES FOR COMMERCIAL AND NON-COMMERCIAL USE

(71) Applicant: ARUNAVA MAJUMDAR, Menlo Park, CA (US)

(72) Inventor: ARUNAVA MAJUMDAR, Menlo Park, CA (US)

(21) Appl. No.: 14/967,252

(22) Filed: Dec. 11, 2015

Related U.S. Application Data
(60) Provisional application No. 62/090,358, filed on Dec. 11, 2014.

(51) Int. Cl. G06Q 30/08; G06Q 30/02

(52) U.S. Cl. CPC G06Q 30/08; G06Q 30/0275

(57) ABSTRACT

In one embodiment, a method for displaying an electronic message with a networked electronically programmable dynamic display (NEPDD) includes executing on a processor the step of receiving at least one bid from one or more display bidders for display space on an NEPDD device to display an electronic message. The method includes the step of notifying one or more NEPDD displayers of the bid. The method includes the step of receiving a bid selection from the one or more NEPDD displayers. The method includes the step of communicating the electronic message along with display instructions to each NEPDD management application of the one or more NEPDD displayers.

### CROSS-REFERENCE TO RELATED APPLICATIONS

This application hereby incorporates by reference in their entirety the following application: U.S. Provisional Patent Application No. 62/090,358 filed on 11 Dec. 2014.

### BACKGROUND OF THE INVENTION

1. Field:

This application relates generally digital advertising, and more particularly to a system and method of networked electronically programmable dynamic displays on personal and commercial properties for commercial and non-commercial use.

2. Related Art:

The Internet of Things (IoT) can be the network of physical objects embedded with electronics, software, sensors, and network connectivity. This can enable these objects to collect and exchange data. The IoT can allow objects to be sensed and controlled remotely existing network infrastructure, creating opportunities for more direct integration between the physical world and computer-based systems, and resulting in improved efficiency, accuracy and economic benefit. At the same time, digital displays can be placed in various public locations and connected to one or more computer and/or cellular networks. Advertise need no longer be provided through traditional media such as television sets, radios, and the like. Thus, method and system are desired for a system and method of networked electronically programmable dynamic displays on personal and commercial properties for commercial and non-commercial use.

### BRIEF SUMMARY OF THE INVENTION

In one embodiment a method for displaying an electronic message with a networked electronically programmable dynamic display (NEPDD) includes executing on a processor the step of receiving at least one bid from one or more display bidders for display space on an NEPDD device to display an electronic message. The method includes the step of notifying one or more NEPDD displayers of the bid. The method includes the step of receiving a bid selection from the one or more NEPDD displayers. The method includes the step of communicating the electronic message along with display instructions to each NEPDD management application of the one or more NEPDD displayers.

### BRIEF DESCRIPTION OF THE DRAWINGS

FIG. 1 illustrates an example system for implementing one or more electronically programmable dynamic displays, according to some embodiments.

FIG. 2 illustrates an example system that can be used to display personal messages with an NEPDD, according to one example.

FIG. 3 illustrates an example use of NEPDDs on personal property for commercial use, according to some embodiments.

FIGS. 4 and 5 depict an example NEPDD process for vehicles, according to some embodiments.

FIG. 6 depicts, in block diagram format, an example NEPDD management server, according to some embodiments.

FIG. 7 illustrates another block diagram of a sample computing environment with which embodiments may interact.

FIG. 8 illustrates an example process for displaying an electronic message with an NEPDD, according to some embodiments.

The Figures described above are a representative set, and are not n exhaustive with respect to embodying the invention.

### DESCRIPTION

Disclosed are a system, method, and article of manufacture of networked electronically programmable dynamic displays (NEPDDs) on personal and commercial properties for commercial and non-commercial use. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied is other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc. to provide a thorough understanding of embodiments of the invention. One skilled in the relevant art can recognize, however, that the invention may be practiced without one or more of the specific details, or with other methods, components, materials and so forth. In other instances, well-known structures, materials, or operations are riot shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting car monitoring period of unspecified duration between enumerated steps of the depicted method. Additionally, the order in which a particular method occurs may or may not strictly adhere to the order of the corresponding steps shown.

Definitions

Cloud computing can be computing in which large groups, of remote servers are networked to allow centralized data storage and online access to computer services or resources.

Geolocation can include the identification of the real-world geographic location of an object, such as a computing device and/or a networked electronically programmable dynamic display (NEPDD).

Mobile application (e.g. a mobile app) mobile app computer program designed to run smartphones tablet computers and other mobile devices.

Radio-frequency identification (RFID) is the wireless use of electromagnetic fields to transfer data, for the purposes of automatically identifying and tracking tags attached to objects.

Rollable display can be a flexible display that can be rolled (e.g. rolled up into a scoll). A rollable display can include electronic ink, Gyricon, OLED, etc.

Exemplary Computer Architecture and Systems

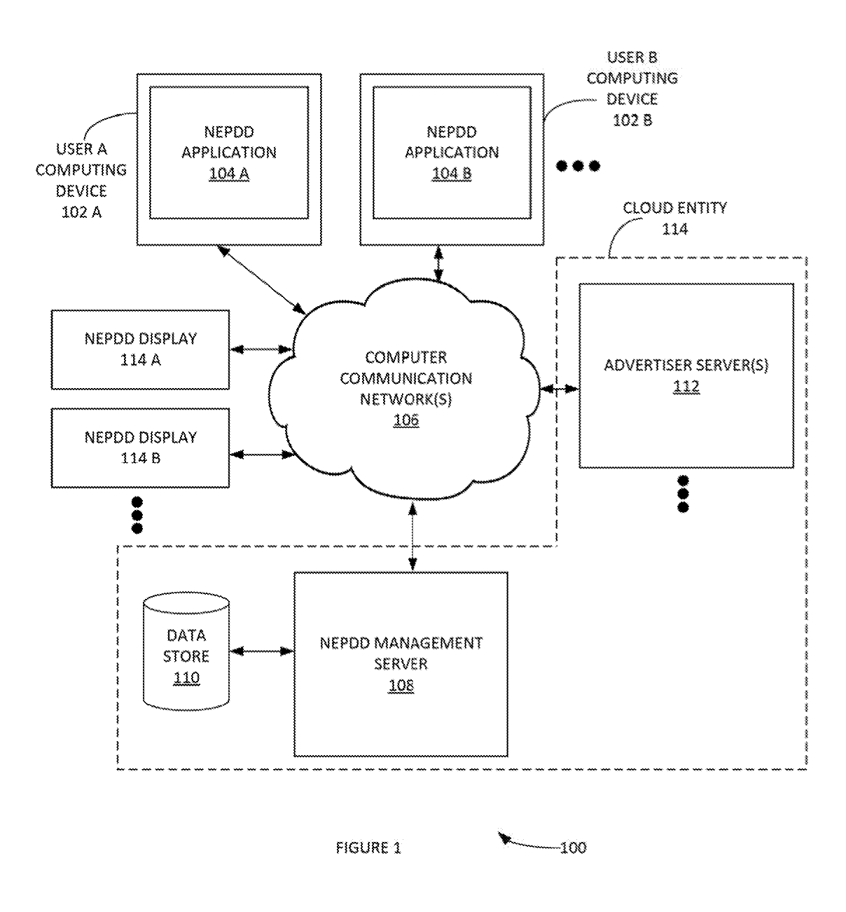

FIG. 1 illustrates an example system for implementing one or more networked electronically programmable dynamic displays, according to some embodiments. System 100 can include one or more user-side computing devices 102 A-B. Computing devices 102 A-B can be mobile device (e.g. smart phones, tablet computers, wearable computing devices, head mounted display devices, etc.).

Computing devices 102 A-B can include NEPDD applications 104 A-B. Computing; devices 102 A-B can securely connect to an NEPDD (e.g. such as NEPDDs 114 A-B infra). For example, computing devices 102 A-B can utilize a wireless technology standard for exchanging data over short distances (e.g. Bluetooth and the like) to communicate with one or more mounted NEPDDs managed by the respective computing device.

NEPDD applications 104 A-B can be used to manage NEPDDs 114 A-B. A user can manage NEPDD applications; 104 A-B to interact with NEPDD management server 108. For example, a user can select bids to accept and then cause an NEPDD to display an advertisement or other electronic message per the accepted bid's instructions. NEPDD applications 104 A-B can provide NEPDD management server 108 verification that an advertisement has been displayed per a bid's instructions. In some examples, NEPDD applications 104 A-B can utilize native systems of computing devices 102 A-B for identifying local viewers (e.g. via an RFID identification signal) and then target the advertisement or, more generally, any displayed message. In another example, the NEPDD can utilize its own native sensors for identifying local viewers (e.g. via an RFID identification signal) and then target the advertisement or, more generally, any displayed message.

Advertiser server(s) 112 can be utilized by various entities (e.g. display bidders) to implement digital advertisements on one more NEPDDs. In one example, advertisements can include marketing communication used to encourage, persuade, or influence an audience (viewers, readers or listeners; sometimes a specific group) to take or continue to take some action. Advertisements can also include public announcements such as law enforcement announcements, Amber alerts, and the like. Advertiser server(s) 112 can provide a client application (not shown) to advertiser computing devices. Client application can include a dashboard for selecting system preference, uploading digital advertisements, reviewing advertisement metrics, paying advertisement costs, bidding for specific sets of NEPDD by locations and times, etc. Advertiser server(s) 112 can interact with various other entities of system 100 to provide advertisement instructions, electronic payments, etc. Advertiser server(s) 112 can be implemented in a cloud-computing platform.

NEPDD management server 108 can be implemented in a cloud-computing platform. Accordingly, in some embodiments, NEPDD management server 108 can be implemented in a cloud entity 114 as provided infra. NEPDD management server 108 can connect advertisers wishing to advertise with one or more NEPDD users (e.g. displayer entities). NEPDD management server 108 can manage a bidding process for use of NEPDDs (e.g. NEPDD devices 114 A-B) based on various attributes of said NEPDDs such as location, user identity, NEPDD size, viewer identity for targeting the message, etc. NEPDD management server 108 can manage payments from advertisers and/or payments to the owners of NEPDDs used for advertisements. NEPDD management server 108 can track the location of NEPDDs. NEPDD management server 108 can track the location of the various NEPDD users and/or viewers. NEPDD management server 108 can utilize a user and/or NEPDD location to manage which advertisements are presented to viewers. NEPDD management server 108 can include functionalities for determining that a viewed and/or otherwise experienced an advertisement on an NEPDD. NEPDD management server 108 can provide an application programming interface (API) for other server-based entities to utilize the NEPDD-based system for advertising. NEPDD management server 108 can utilize various geolocation techniques (e.g. GPS, ALPS, radio frequency (RF) location, cell tower triangulation, IP address, MAC address, RFID, hardware embedded article/production number, embedded software number, invoice, Wi-Fi positioning system, device fingerprint, canvas fingerprinting, and/or any combination thereof). It is noted that viewers can opt-in with NEPDD management server 108 to have their locations tracked in order to receive targeted advertisements. NEPDD management server 108 can include a database management system (DBMS) and stare relevant data in datastore 110.

NEPDDs 114 A-B can be mounted on various location such as, inter alia, personal properties/objects such as automobiles, clothing worn by individuals and/or real-estate to display a combination of images and/or words for commercial and non-commercial use NEPDDs 114 A-B can also be mounted on commercial properties such as, inter alia, commercial automobiles, buildings and/or bill boards to display a combination of images, words and/or both for commercial and non-commercial use. NEPDDs 114 A-B can include outward facing cameras identifying users that view advertisements. In this way, advertisement consumption rates can be tracked for purposes of compensation displaying entities.

NEPDDs 114 A-B can include active light-emitting devices (e.g. a rigid or flexible substrate light-emitting diode) and/or passive display devices (e.g. rely on reflection of ambient light). An NEPDD can include a rollable display. NEPDDs 114 A-B can further include a power source, integrated circuit (e.g. a video ‘chip’ and/or a communication ‘chip’). Optionally, NEPDDs 114 A-B can include a sensor to sense other NEPDDs and/or viewer identifier devices (e.g. an RFID that uniquely identifies a local viewer). In one example, the pixels of NEPDDs 114 A-B can be electronically programmed using to display words, images or a combination of both. Each digital device (e.g. 102A) can be connected to multiple displays (e.g. 114A-B), The NEPDD displays can be recognized with an identification code unique to the NEPDD. NEPDD can establish a secure connection with computing device used to manage the NEPDD (e.g. mobile device, a computing device in an automobile, etc.).

Computer communication networks 106 can be a data network (e.g. a telecommunications network) that allows computers to exchange data. Computer communication networks 106 can be a TCP/IP network such as the Internet. Computer communication networks 106 can be wide area network enterprise private networks, virtual private network, cellular data networks and/or local area networks, etc.

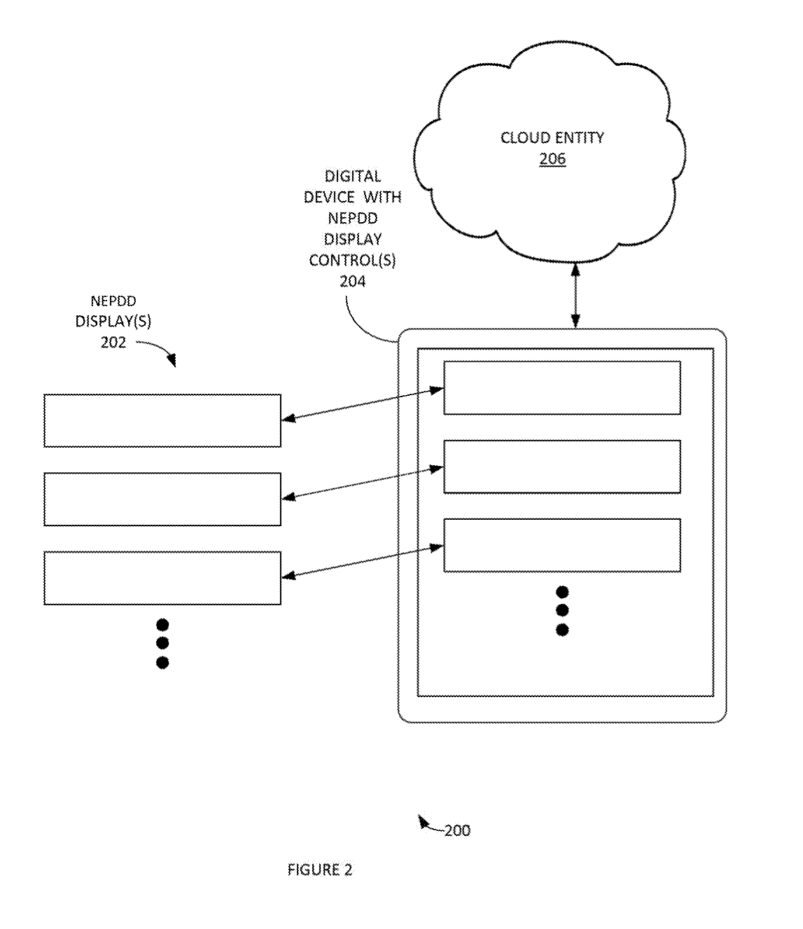

FIG. 2 illustrates an example system 200 that can be used to display personal messages (e.g. “Go Giants” or “John Doe for President 2016”) with an NEPDD, according to one example. These personal messages can be programmable, dynamic and modifiable. In a personal message embodiment, the NEPDD(s) 202 can be used for non-commercial purposes For example, a displayer entity may not be compensated for displaying a message and/or image with an NEPDD(s) 202 However, networking the digital device 204 to a cloud entity 206 provides both business opportunities as well as a mechanism for public announcements, as outlined below NEPDDs 202 can be placed by displayer entities n personal clothing, as ‘bumper stickers’ on vehicles, on personal property, in window, and the like. Various types of application and removal methods can be utilized (e.g. magnetic and/or mechanical connectors) such that an NEPDD(s) 202 can be relocated and/or removed from a vehicle/clothing/property due to changing weather conditions.

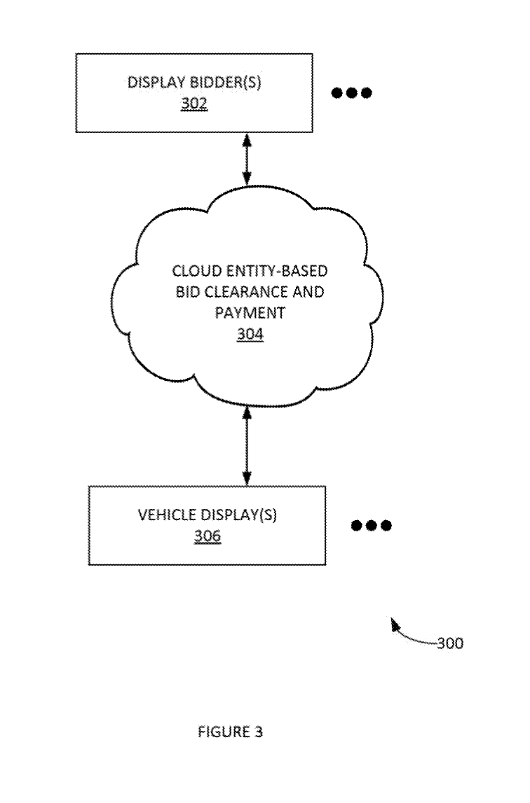

FIG. 3 illustrates an example system 300 of NEPDDs on personal property for commercial use, according to some embodiments. In one example, NEPDDs can be attached to personal vehicles (e.g. cars, trucks, bicycles, motorcycles, skate boards, etc.) for the display of commercial messages. It is noted that this embodiment can be modified for personal clothes worn in public, small display billboards on personal real estate, and the like. Continuing with the present example of FIG. 3, three entities (e.g. corporations, cohorts of people, institutions etc.) can utilize the system as shown.

Display bidder(s) 302 can bid (e.g. on a pay per hour, per month, per miles on the road, per location of a vehicle, etc.) for display space on a personal vehicle on the road to display a message (e.g. advertisement, a political statement, a religious statement, educational information, etc.). For example, a display bidder ‘i’ can financially bid for displaying its message for public view by a displayer (e.g. a user that manages an NEPDD 114 A-B of FIG. 1). Various types of displayers can be available such as, inter alia; a vehicle displayer 306 (as in the present example) clothing displayers (e.g. an NEPDD attached to the back of a person's jacket home displayer, a yard-sign displayer, etc.). If the bid is selected by the displayer, the display bidder can then pay the displayers at an agreed-upon rate and/or contract stipulation. The relationship between the displayer 302 and display bidder 306 can be mediated by an NEPDD management server 304 (e.g. and/or other functionality of the cloud-based entity 114 of the present example) and its various algorithms/rules.

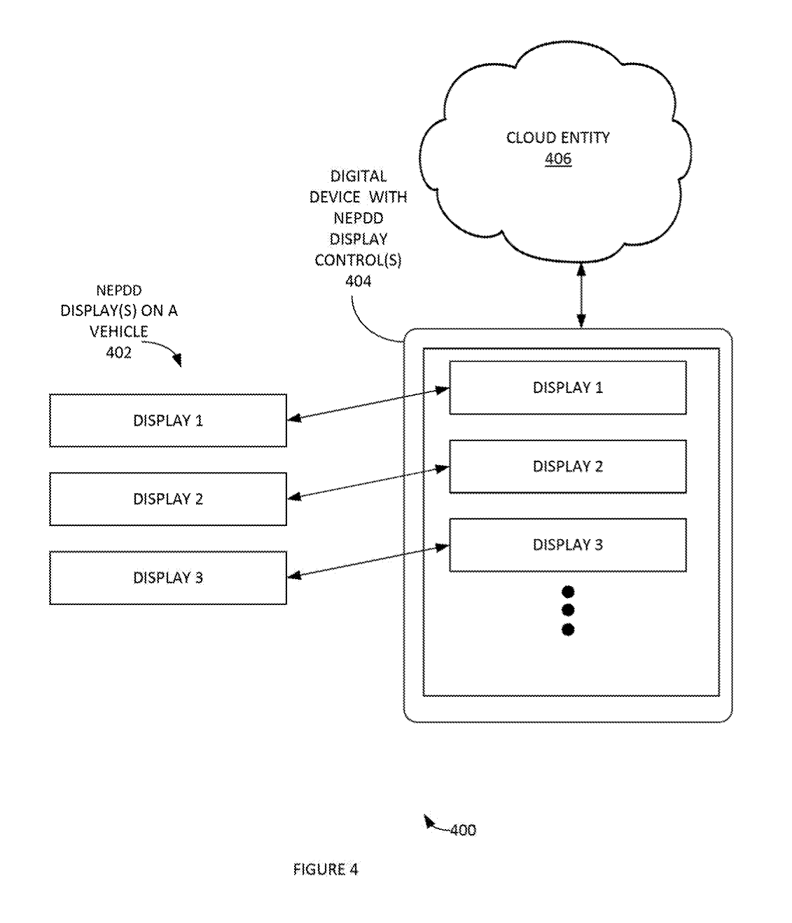

Displayers 306 can select the bids made by display bidders 302 based on a variety of criteria—maximize income, personal choice, etc. Each displayer 306 (e.g. displayer ‘j’) can have multiple displays, display ‘j1’ through ‘jk’, on a single vehicle. Each displayer 302 an select a different display bidder for each of its displays ‘j1’ through ‘jk’ (e.g. see FIG. 4 infra).

A cloud-based entity 304 (e.g. a cloud entity 114 supra) can connect the display bidders 302 and displayers 306 by receiving bids from the display bidders 302 and clearing bids based on displayers choices and enable financial transaction (e.g. payments, services, trades of goods, etc.) from display bidders 302 to displayers 306. Cloud-based entity 304 can provide various user interfaces for administrators of displayer entities 306 and display bidder entities 302 to interact with the present system. Cloud-based entity 304 can provide one or more API's for remote computer-based entities (e.g. displayer/advertisers) to obtain information and provide instructions to said cloud-based entity.

A viewer can be a person who has opted in to view, may or may not be part of display bidder or displayer group, but is willing to be targeted for messages to be displayed by display bidder 302 and displayer 306. In it noted that, in some examples, viewer an be tracked by cloud-based entity. For example, cloud-based entity can track the location of a viewer's mobile device. In an example where the viewer is wearing a head-mounted display (e.g. Google Glass® and the like), the cloud-based entity can track whether the viewer viewed an advertisement and/or the length of the portion of viewed. In the example where the NEPDD device or a viewer's wearable computing system includes a user-facing camera, the cloud-based entity can include processes for analysis view sentiment and/or other attributes while viewing the advertisement. Cloud-based entity 304 can utilize this information (e.g. user views statistics, user sentiment statistics, etc.) in setting bid prices for showing advertisements. Cloud-based entity 304 can also utilize displayer 306 and/or viewer location in setting a bid price. For example, a displayer 306 in a prestigious and/or crowded location can be associated with a higher bid cost than a displayer 306 in a less prestigious and/or less crowded location. View demographic information (e.g. age, sex, professional status, educational background, etc.) can also be utilized in setting, bids.

In one example, it can be determined that a displayer 306 is within the field of view of a high-paid professional. Cloud-based entity 304 can set the bid price at a higher rate for display bidder 302 to display an advertisement for that period of time. It is noted that cloud-based entity 304 can include various prediction and machine learning modules to predict when a displayer will be within the field of view of various viewers (e.g. based on location and direction/speed of travel). In this way, display bidders can be notified prior to a view event and make bids accordingly. Accordingly, various parameters (e.g., co-location, field of view, viewer attributes, number of viewers, etc.) can be utilized to set a bid price.

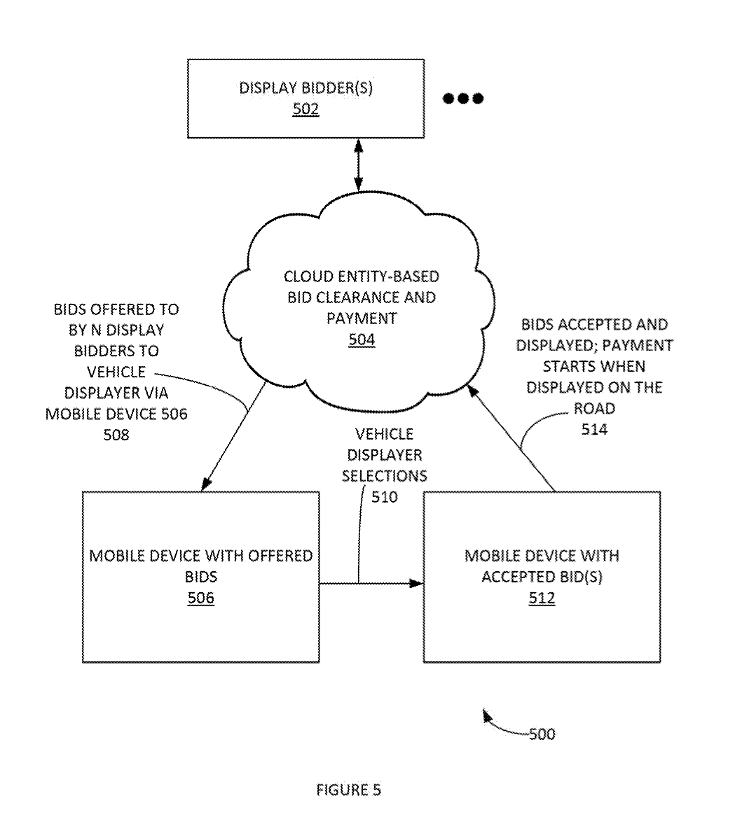

FIGS. 4 and 5 depict an example NEPDD processes 400 and 500 for vehicles, according to some embodiments. Again, it is noted that the example NEPDD processes 400 and 500 can be generalized to displays on other types of personal properties. It is also noted, that in some embodiments provided herein the cloud connectivity can be to a mobile computing system installed in a vehicle as opposed to the displayer's personal mobile device. For example, an autonomous vehicle (e.g. Google Self-Driving Car) can include an application in its computing system for managing NEPDD devices both on the exterior and/or interior of said vehicle.

In the present example, verification of the NEPDD display 402 in public view can be ascertained by the location of the smart phone and/or the vehicle via well-known GPS and/or cell-based triangulation. For example, when the vehicle is parked in a garage and not in public view, hen there no payment by the display bidder to the displayer. On the other hand, when both the vehicle and the smart phone (e.g. mobile device 404) are co-located and are on a street in public view, then the payments can be effectuated. Furthermore, the rates of payments for the display bidder to the displayer can be determined by the congestion on the streets, the number of people who could potentially view the message, etc. Cloud-based entity 406 can manage process 400.

In process 500, display bidders 502 can utilize, cloud entity-based bid clearance and payment entity 504. In step 508, loud entity-based bid clearance and payment entity 504 can provide bids offered to by display bidders 502 to a vehicle displayer via mobile device with offered bids 506. In step 510, vehicle displayer (e.g. vehicle displayer via mobile device with offered bids 506) can make bid selections. Mobile device with accepted bid(s) 512 bids can display accepted bids. In step 514, the payment starts when it is confirmed that the display is displayed on the road (or in another public forum).

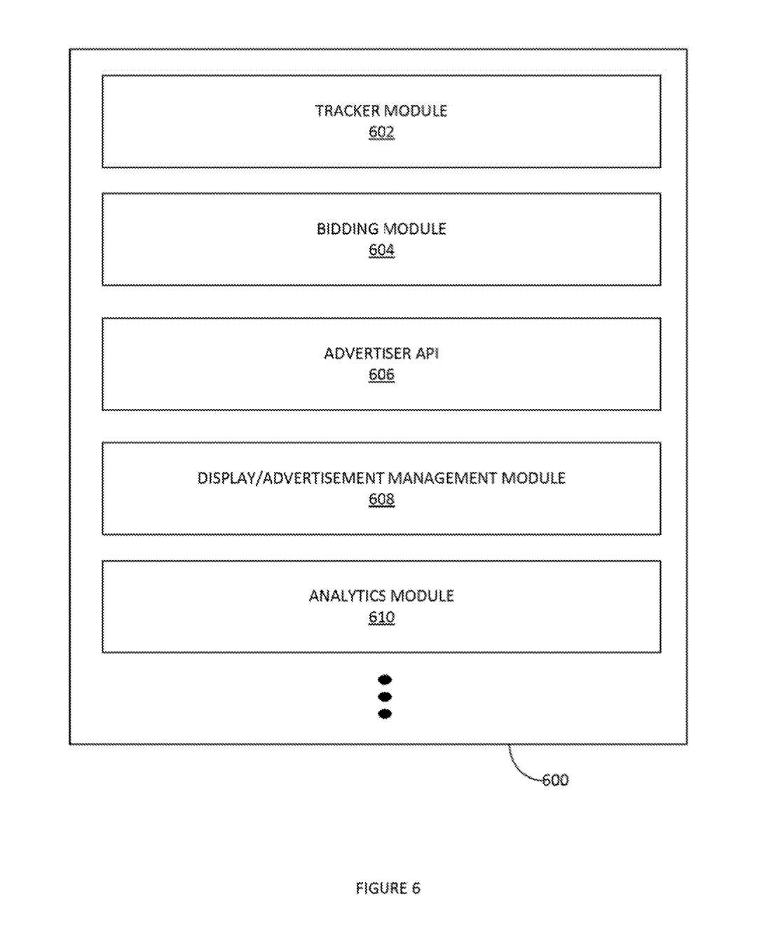

FIG. 6 depicts, in block diagram format, an example NEPDD management server 600, according to some embodiments. In some example embodiments, NEPDD management server 600 can be implemented as a cloud-based entity provided in the description of FIGS. 4 and 5 supra.

Tracker module 602 can track the various mobile entities of FIG. 1 and/or the viewers of FIGS. 2-5. As provided supra, tracker module 602 can utilize various geolocation methodologies to determine locations of said entities. In some examples, tracker module 602 can utilize analytics module 610 to predict future locations of said entities.

Bidding module 604 can manage bids by displaying entities and/or other advertisers. Bidding module 604 can notify displayers of said bids and manage bid acceptance. Bidding module 604 can track advertisement views and/or viewer sentiments when the information is available according to some embodiments. Bidding module 604 can further manage payments to displayers. Advertiser API 606 can enable remote displayer/advertiser entities to obtain information and provide instructions to said cloud-based entity.

Display/Advertisement management module 608 can manage the display of advertisements and/or other media on NEPDD displays. Display/Advertisement management module 608 can match advertisements to specific NEPDD displays based on information provided by the other modules of NEPDD manage 600. Display/Advertisement manage module 548 can record the time and location of displayed advertisements.

Analytics module 610 can implement various computer analytics methods. Analytics module 610 can implement machine learning methods. Analytics module 610 can implement various machine learning, prediction and/or optimization techniques to improve NEPDD services. Machine learning can be a subfield of computer science and statistics that constructs and studies of systems that can learn from data (e.g., as opposed to only explicitly programmed instructions). Example optimization techniques can include a stochastic gradient algorithms other gradient algorithms, evolutionary algorithms, combinatorial optimization algorithms, etc. Example machine learning algorithm can include, inter alia; supervised learning algorithms; unsupervised learning algorithms; semi-supervised learning; transductive inference; reinforcement learning; developmental learning, decision tree learning; association rule learning; artificial neural networks; support vector machines; clustering; etc. Statistical techniques that can be utilized by analytics module 610 for prediction include regression analysis and time series analysis, and their various sub-categories such as ordinary least squares, logistic regression, autoregressive moving average models, and vector auto-regression models. NEPDD management server 600 can include other module (not shown) such as web servers, database mangers, application servers, e-commerce servers or managing payments and money transfers, etc.

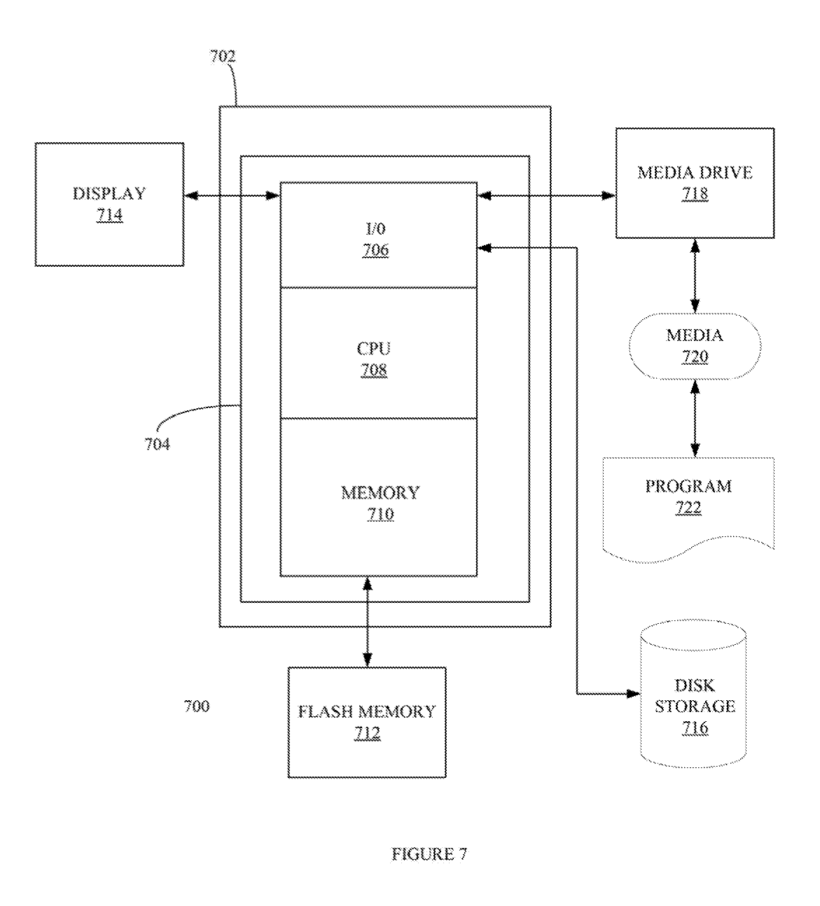

FIG. 7 depicts an exemplary computing system 700 that can be configured to perform any one of the processes provided herein. In this context, computing system 700 may include, for example, processor, memory, storage, and I/O devices (e.g., monitor, keyboard, disk drive, Internet connection, etc.). However, computing system 700 may include circuitry or other specialized hardware for carrying out some or all aspects of the processes. In some operational settings, computing system 700 may be configured as a system that includes one or more units, each of which is configured to carry out some aspects the processes either in software, hardware, or some combination thereof.

FIG. 7 depicts computing system 700 with a number of components that may be used to perform any of the processes described herein. The main system 702 includes a motherboard 704 having an I/O section 706, one or more central processing units (CPU) 708, and a memory section 710, which may have a flash memory card 712 related to it. The I/O section 706 can be connected to a display 714, a keyboard and/or other user input (not shown), a disk storage unit 716, and a media drive unit 718. The media drive unit 718 can read/write a computer-readable medium 720, which can contain programs 722 and/or data. Computing system 700 can include a web browser. Moreover, it is noted that computing system 700 can be configured to include additional systems in order to fulfill various functionalities. Computing system 700 can communicate with other computing devices based on various computer communication protocols such a Wi-Fi, Bluetooth® (and/or other standards for exchanging data over short distances include those using short-wavelength radio transmissions), USB, Ethernet, cellular, an ultrasonic local area communication protocol, etc.

Exemplary Methods

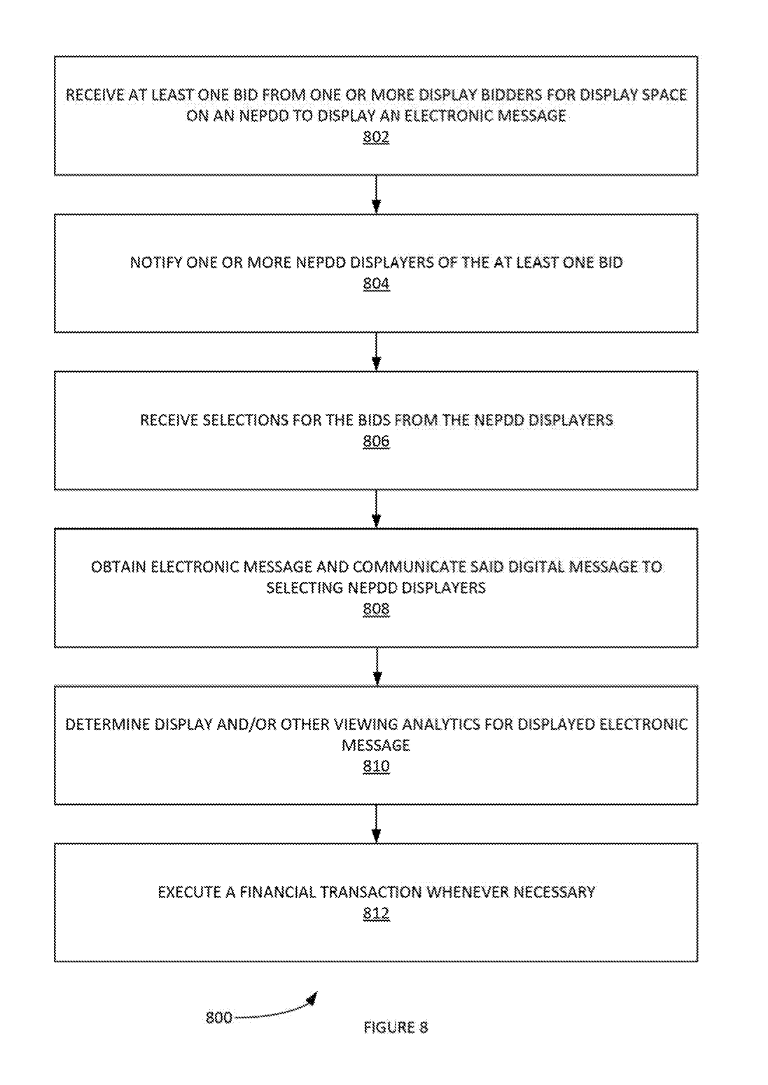

FIG. 8 illustrates an example process 800 for displaying an electronic message with an NEPDD, according to some embodiments. In step 802 of process 800, at least one bid can be received from one or more display bidder (e.g. advertisers) for display space on an NEPDD device to display an electronic message (e.g. an advertisement, a public announcement, etc.). The electronic messages can be text, audio, video and/or other media formats. The displayer entities can utilize a dashboard and/or client application to upload the electronic message and/or provide the bid. The bid can designate attributes of the NEPDD device such as location, size, time to display digital message, etc.

In step 804, one or more NEPDD displayers can be notified of the bid. For example, a push notification can be communicated to a user-side application that an NEPDD displayer uses to manage an NEPDD device. In some examples, the NEPDD displayer can counter bid after reviewing a bid from a display bidder.

An NEPDD displayer can select a bid in step 806. The user-side application can be used to select a bid and generate a notification message. In step 808, the electronic message can be obtained (e.g. from a database of previously stored electronic messages and/or directly from the display bidder). The electronic message can then be communicated, along with display instructions (e.g. time and/or location of display) to the selecting NEPDD displayer's NEPDD management application (e.g. NEPDD applications 104 A-8 of FIG. 1). Accordingly, the electronic message can be displayed on the one or more NEPDD devices managed by the NEPDD displayer.

In step 810, the display and/or other viewing analytics for the displayed electronic messaged can be determined. For example, the location, duration and/or other statistical information can be gathered. This information can be communicated to the appropriate display bidder for review. A cloud-based entity can manage process 800. In step 812, a financial transaction can be executed whenever necessary.

The systems of FIGS. 1-7 can be used to implement process 800 and/or other methods provided herein, according to various embodiments. It is further noted, that in some examples, a computing device such a laptop and/or a personal computer can be utilized in lieu of a mobile device.

Exemplary Use Cases

In one example, a user can place an NEPDD device on an article of clothing such as a hat. The user can download an NEPDD device management application to her smart phone. The user can notify an NEPDD service implemented on a cloud-commuting platform of various times and/or location that the user's NEPDD device will be available for displaying commercial messages. Advertiser entities can use the NEPDD service to bid to place digital advertisement and/or other types of electronic messages on the users NEPDD device. The user can receive notices of said bids via the NEPDD device management application. The user can accept and/or reject bids. The NEPDD device management application can be used by the NEPDD service to verify that the user display the digital advertisements at the tunes and/or locations previously agreed upon in the terms of the bids accepted by the users. The NEPDD device management application can also be used to recompense the user for verified displays of the digital advertisements per the bid terms. In other examples, the NEPDD device can be placed on the user's jacket, automobile, yard sign, home, business window, etc.

Various methods of targeted bidding to a viewer can be implemented by the present systems and methods. In one example, a viewer can be walking down a street or in a car driving down the street. She may or may not be part of either the displayer and/or the display-bidder group. The viewer has opted in to sharing her location with the cloud-based entity. Local businesses (e.g. restaurants, retail stores, movie theaters, etc.) that are part of the display-bidder group may want to advertise to the viewer using the available NEPDD displays (e.g. NEPDD on vehicles in front clothes worn by the people in front of the viewer, real-estate property directly in line of sight of the view etc.) that the viewer can see based on the viewer's location, direction of motion and line of sight. This connection between the viewer's location, direction of motion, his/her preferences and choices as well as match making with local display bidders and/or displayers can be orchestrated by the cloud-based entity. The displayers may choose to opt in for a “targeted option” as opposed to selecting the bids made by display bidders. In this example, the responsibility of selecting the display bidders can be handed over to the cloud-based entity. Specific choices can be made should the displayer decide not to display certain types of messages (e.g. those containing alcohol, religious messages, political ads, etc.), which is the choice of the displayer.

Various methods of NEPDD displays for public messages can be implemented by the present system. Public messages can include, inter alia, messages can be related to emergencies, traffic congestion (e.g. minutes to the airport), child abduction, educational messages, etc. Public messages can be shown on NEPDD displays mounted on private and/or commercial properties. Public messages can be orchestrated through the cloud-based entity via a payment and/or for free depending on the nature of the public announcement and/or local governmental regulations.

In some embodiments, display costs and/or minimum bid values can be set according to various factors such as, inter alia: the status of the displayer, the type of vehicle upon which the NEPDD is located, the NEPDD's current location, the status of a sensed local viewer, the size and quality of the NEPDD display, and the like. In some embodiments, the displayer can be in a ‘maximize my bids’ mode in which the loud-based entity can automatically select bids on behalf of the displayer that maximize the displayer's income. In another mode, the displayer can manually select bids and/or display content. In some embodiments, a NEPDD can be an electronic-ink display attached to a consumer good (e.g. a cup, a wallet, a suitcase,a notebook, a text book, a remote control device, a food container, a liquid container, a tool, etc.). For example, an educational institution can utilize an electronic ink-based NEPDD device attached to a text book to provide educational electronic messages to a student. In another example, an electronic-ink-based NEPDD device can be attached to a food container such as a milk cartoon. The corporation associated with the milk product can remotely manage the electronic-ink-based NEPDD device. Various relevant advertisements related to the milk product and/or other associated food products can be displayed to viewers.

### CONCLUSION

Although the present embodiments have been described with reference to specific example embodiments, various modifications and changes can be made to these embodiments without departing from the broader spirit and cope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than restrictive sense. In some embodiments, the machine-readable medium can be a non-transitory form of machine-readable medium.

An example of environment capturing is now provided. An additional benefit of doing the visual analysis of the pages would be the fact that we an also record the ad environment in which it's tested. For example, if the area where the ad is tested had black background and white can record this fact, and utilize them when we create ads for testing. In this specific case, the ad which will be created can be with black background and white text (blending in) or white background and black text (contrast).

What is claimed:

1. A method for displaying an electronic message with a networked electronically programmable dynamic display (NEPDD) comprising executing on a processor the steps of:
receiving at least one bid from one or more display bidders for display space on an NEPDD device to display an electronic message;
notifying one or more NEPDD displayers of the bid;
receiving a bid selection from the one or more NEPDD displayers;
communicating the electronic message along with display instructions to each NEPDD management application of the one or more NEPDD displayers.

2. The method of claim 1, wherein the display bidder comprises an advertising entity.

3. The method of claim 1, wherein the electronic message comprises an advertisement or a public announcement.

4. The method of claim 3, wherein the electronic message is in a digital text, digital audio, or a digital video format.

5. The method of claim 1, wherein the step of notifying one or more NEPDD displayers of the bid further comprises:
communicating a push notification to a user-side application that an NEPDD displayer uses to manage an NEPDD device; and
receiving a counter bid from the NEPDD displayer after reviewing a bid from a display bidder.

6. The method of claim 1,
wherein the display instructions comprise an electronic-message time instruction and a location of electronic-message display instruction, and
wherein the bid further comprises the display instructions.

7. The method of claim 1 further comprising:
displaying the electronic message with one or more NEPDD devices managed by the one or more NEPDD displayers.

8. The method of claim 7 further comprising:
obtaining a set of display analytics for a displayed electronic messaged, wherein the set of display analytics comprises a location and a duration of the displayed electronic message.

9. The method of claim 8 further comprising:
executing a financial transaction that compensates the one or more NEPDD displayers based on the bid.

10. A computerized system for displaying an electronic message with an networked electronically programmable dynamic display (NEPDD) comprising:
at least on processor configured to execute instructions;
at least one memory containing instructions when executed on the processor, causes the processor to perform operations that:
receive at least one bid from one or more display bidders or display space on an NEPDD device to display an electronic message;
notify one or more NEPDD displayers of the bid;
receive a bid selection from the one or more NEPDD displayers;
communicate the electronic message along with display instructions to each NEPDD management application of the one or more NEPDD displayers.

11. The computerized system of claim 10, wherein the display bidder comprises an advertising entity.

12. The computerized system of claim 11, wherein the electronic message comprises an advertisement or a public announcement.

13. The computerized system of claim 12, wherein the electronic message is in a digital text, digital audio, or a digital video format.

14. The computerized system of claim 13, wherein the least one memory containing instructions when executed on the processor, causes the processor to perform operations that:
communicate a push notification to user-side application that an NEPDD displayer uses to manage an NEPDD device; and
receive a counter bid from the NEPDD displayer after reviewing a bid from a display bidder.

15. The computerized system of claim 14, wherein the least one memory containing instructions when executed on the processor, causes the processor to perform operations that:
display the electronic message with one or more NEPDD devices managed by the one or more NEPDD displayers; and
obtaining a set of display analytics for a displayed electronic messaged, wherein the set of display analytics comprises a location and a duration of the displayed electronic message.

16. The computerized system of claim 15, wherein the least one memory containing instructions when executed on the processor, causes the processor to perform operations that:
executing a financial transaction that compensates the one or more NEPDD displayers based on the bid.
